(19) United States
(12) Patent Application Publication
(10) Pub. No.: US 2003/0195799 A1
(43) Pub. Date: Oct. 16, 2003

(54) Quality management in process flows

(76) Inventors: Juergen Scholl, Bretten (DE); Dirk Rohdemann, Muehlhausen (DE); Thomas Vomhof, Wiesloch (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/210,892

(22) Filed: Jul. 31, 2002

Related U.S. Application Data
(60) Provisional application No. 60/372,896, filed on Apr. 15, 2002.

(51) Int. Cl. G06F 17/60

(52) U.S. Cl. 705/11

(57) ABSTRACT

A computer program product for combining quality management with a process flow. The product can include instructions to cause a processor to combine a quality management method with a process element hierarchy having a root and describing a process flow. The quality management method describes an activity for managing the quality of the process flow described by the process element hierarchy. The computer program product can be tangibly stored on machine readable media.

### CROSS-REFERENCE TO RELATED APPLICATIONS

This application claims the priority of U.S. Provisional Application Serial No. 60/372,896, attorney docket number 13907-013P01, filed Apr. 15, 2002 and entitled “RECIPE MANAGEMENT,” which is hereby incorporated by reference in its entirety.

### BACKGROUND

This invention relates to process flows.

A process flow is a sequence of chemical, physical, or biological activities for the conversion, transport, or storage of material or energy. For example, process flows are used for the production of specialty chemical products, pharmaceutical products, fuels, cosmetics, and foodstuffs. Recipes include information related to the process flow for the production of a product. Recipes can also include definitions of resources such as equipment that is deployed to perform the process flow, as well as materials input to perform the process flow and output materials resulting from performance of the process flow.

There are different classes of recipes. General recipes (“GR”) include information related to the process flow independent of specific production resources. General recipes identify raw materials, relative quantities, and required processing, but lack specific information regarding a particular site or the resources available at that site. Site recipes (“SR”) include site-specific information related to the local constraints, such as language and available raw materials at a particular production locale. Master recipes (“MR”) include resource capabilities such as equipment deployable to perform a process flow, and describe activities for a specific production on a specific line. Master recipes can also include information that is specific to a process cell.

One use of process flows and recipes is in the manufacture and the production of products. In this case, a process flow typically represents some manufacturing or production operation. The information included with the process flow in a recipe describes, e.g., the manufacturing or production process, raw materials, and available equipment.

### SUMMARY

The present invention provides methods and apparatus, including computer program products, for combining quality management with process flows.

In general, in one aspect, a computer-implemented method for combining quality management with a process flow includes receiving process flow information describing a sequence of activities in the process flow, receiving quality management information describing quality management of a particular activity in the sequence, and combining the quality management information with the process flow information.

The invention can be implemented to include one or more of the following advantageous features. Receiving quality management information can include receiving an inspection method describing a method for managing quality of the particular activity, and receiving an inspection characteristic identifying a trait of the particular activity and a stream in the particular activity during execution of the process flow. An upper limit of a value of the trait can be received as the inspection characteristic.

The quality management information can be accessed from a second process flow. The quality management information can be referenced in the second process flow, or in a master recipe. Referencing the quality management information from the second process flow can include preventing change in the referenced quality management information.

Receiving quality management information can include receiving instructions for deploying a resource to manage the quality of the particular activity, such as, e.g., generating instructions for deploying a piece of equipment based on information about operation of the piece of equipment or receiving instructions to manage the quality of an output stream of the particular activity.

Combining quality management with a process flow can also include selecting a piece of equipment for managing the quality of the particular activity in the sequence, performing the process flow, or receiving second process flow information describing a second sequence of activities in a second process flow and combining the quality management information with the second process flow information.

Combining the quality management information with the process flow information can include associating a quality management activity with an activity of the process flow. This can be done, e.g., by associating a quality management activity with a process element in an element hierarchy when the process element describes an activity in the process flow.

Combining the quality management information with the process flow can include adding a quality management element into an element hierarchy when the element hierarchy includes a collection of process elements describing activities in the process flow. Receiving process flow information can also include receiving a sequence of activities for a conversion of a material.

In another general aspect, a computer program product for combining quality management with a process flow includes instructions to cause a processor to combine a quality management method with a process element hierarchy having a root and describing a process flow. The quality management method describes an activity for managing the quality of the process flow described by the process element hierarchy. The product is tangibly stored on machine readable media.

The invention can be implemented to include one or more of the following advantageous features. The instructions can also cause the processor to retrieve the quality management element from a collection of quality management elements, or to insert the quality management element into the process flow hierarchy as one of a process stage element, a process operation element, and a process action element.

The quality management method can be combined with the process element hierarchy by referencing a child method in a second process element hierarchy describing a second process flow. The process element hierarchy can be part of a first master recipe and the child method can be combined with a second master recipe. Information about the quality management method can be received from a user.

The instructions can also cause the processor to allocate resources, such as equipment, to the quality management method, or to combine the quality management method with a second process flow hierarchy having a second root and describing a second process flow. The quality management method can be combined with a master recipe or with a general recipe. The quality management method can be inserted into the process element hierarchy as an independent element.

The instructions can also cause the processor to combine an inspection method describing an inspection activity for determining a trait of one of an activity in the process flow, a piece of equipment used in the process flow, and a stream in the process flow with the process element hierarchy. The inspection method can include an inspection characteristic describing a desired value of the trait.

The quality management method can be customized to a characteristic of the process element hierarchy to, e.g., account for the particular placement of the quality management method within the process element hierarchy. The quality management method can be combined with a process flow hierarchy that describes a sequence of activities for a conversion of a material.

The invention can be implemented to realize one or any combination of the following advantages. A system in accordance with the invention can include quality management in process flows. By combining quality management with the process flow, the system adds, to the process flow, methods and information for confirming that an execution of a process flow will meet expectations. Quality management during execution also allows the process flow to be adjusted to accommodate variability in execution. Moreover, monitoring the quality and traits of activities or material streams in the process flow automatically collects data that is useful in improving and debugging process flows.

By adding inspection method elements to a recipe, a user can increase or decrease production of a product more rapidly. In particular, a user can define a library of common inspection method elements and then use the library to combine a single inspection method element into several different recipes. The library of inspection method elements can also be received from the manufacturer of quality management equipment. The manufacturer can supply the inspection method elements to the user to ensure that the user is easily able to integrate the manufacturer's equipment into a production line.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 shows a method for combining quality management with process flows.

FIG. 2 shows an example table that includes quality management information.

FIG. 3 shows another method for combining quality management with process flows.

FIG. 4 shows one description of a process flow, namely a process flow hierarchy in a recipe.

FIG. 5 shows an implementation of the method of FIG. 1 for combining quality management with process flows.

FIG. 6 shows another implementation of the method of FIG. 1 for combining quality management with process flows.

FIG. 7 shows a schematic representation of a process flow.

FIG. 8 shows a schematic representation of a process flow after combination with quality management information.

FIG. 9 shows another implementation of the method of FIG. 1 for combining quality management with recipes.

FIG. 10 shows a system for combining quality management with process flows.

FIG. 11 shows quality management can also be combined with a recipe using a root dependent inspection method.

FIG. 12 shows an example screen display listing inspection characteristics of a recipe using a locked icon.

Like reference symbols in the various drawings indicate like elements.

### DETAILED DESCRIPTION

FIG. 1 shows a method 100 for combining quality management with a process flow. A system performing the method 100 receives process flow information describing a process flow (step 105). A process flow is a sequence of chemical, physical, or biological activities for the conversion, transport, or storage of material or energy. The process flow information can describe the process flow even in the absence of information about the resources used to perform the process flow. For example, the process flow information can describe that a mixture with a certain viscosity is to be mixed at a certain rate and temperature without identifying a particular mixing vessel. The process flow information can be received, e.g., directly from a user, retrieved from a process flow database, or received from a second, remote system.

The system also receives quality management information describing the quality management of an activity described in the process flow information (step 110). The quality management information can include, e.g., information about methods for managing the quality and traits of equipment and materials involved in the process flow. For example, the quality management information can specify a method for measuring the transmissivity of a temporary suspension, the range of acceptable transmissivities of a particular temporary suspension, the acceptable black noise of a spectrophotometer for making a transmissivity measurement, and what to do if the transmissivity of the temporary suspension is outside the acceptable range.

The system then combines quality management information with the process flow (step 115). For example, the system can add a method for managing quality directly into the sequence of activities in the process flow. The system can also allocate resources for managing quality to the process flow. Resources can includes, e.g., the equipment available at a particular site for performing the process flow.

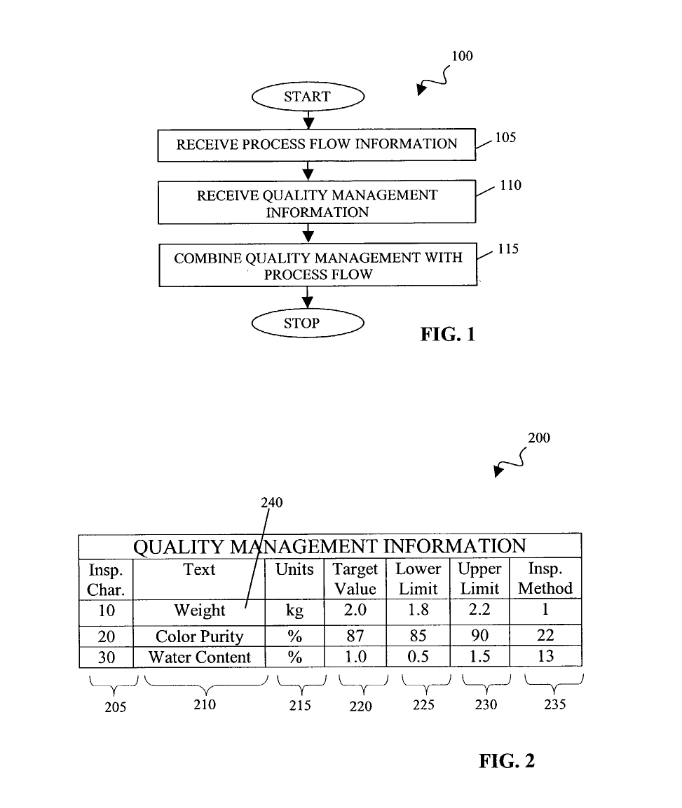

FIG. 2 shows an example table 200 that includes quality management information that can be included in a process flow. Table 200 includes an inspection characteristic field 205, a text description field 210, a unit field 215, a target value field 220, a lower limit field 225, an upper limit field 230, and an inspection method field 235. Inspection characteristic field 205 includes information identifying various inspection characteristics. Inspection characteristics are traits of a process, equipment, or the streams in a process during execution. Text description field 210 includes text descriptions of the corresponding inspection characteristics. For example, a text description 240 is associated with inspection characteristic 10 and relates to involves the weight of a batch stream during execution Target value field 220 includes information identifying the target values of the corresponding inspection characteristics. The target values are in units identified in unit field 215. For example, target value description 250 indicates the target value of the corresponding inspection characteristic is 2.0 kg. Lower limit field 225 includes information identifying the lower limits of the values of the corresponding inspection characteristics. Upper limit field 230 includes information identifying the upper limits of the values of the corresponding inspection characteristics. The lower limits and the upper limits are in units identified in unit field 215.

Inspection method field 235 includes information identifying methods for determining the values of the corresponding inspection characteristics. A system that accesses table 200 can use inspection method field 235 to locate instructions for performing inspection.

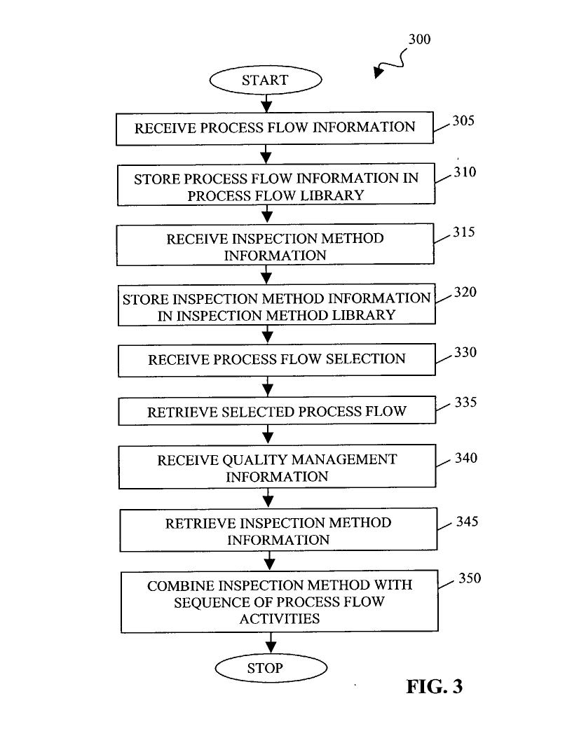

FIG. 3 shows another method 300, in accordance with the invention, for combining quality management with a process flow. A system performing method 300 receives process flow information (step 305) and stores the process flow information in a library of process flow information (step 310). The system can group related process flow information in the process flow library by, e.g., industry or product, process flow class, process flow ancestry, input or output materials, or other denominators. The system thereby establishes a process flow library from which information about individual process flows can be accessed, as needed.

The system also receives inspection method information that includes instructions for performing a method for determining the values of inspection characteristics (step 315). The received instruction can be created by a relatively skilled technician and distributed to different plants or to systems operated by individuals who lack a detailed technical understanding of the activities described by the instructions. The instructions can also be created by copying existing instructions from other process flows, as discussed further below.

The system stores the received inspection method information in association with other inspection method information to establish a library of inspection methods (step 320). The system can group related instructions in the inspection method library by, e.g., industry or product, a class of process flow where the inspection methods are commonly used, input or output materials, or a process flow activity commonly associated with the inspection method. Individual inspection method information can be “withdrawn” from the inspection method library, as needed.

The system receives a selection identifying that quality management is to be combined with a selected process flow from the process flow library (step 330). The system retrieves the selected process flow from the process flow library (step 335) such as, e.g., from a process flow library located at a remote site. The system also receives quality management information describing quality management of an activity described in the selected process flow (step 340). The received quality management information can include a distinguishing characteristic, such as a name or a file extension, of a particular inspection method in the inspection method library. For example, the received quality management information can be a record from table 200 that includes inspection characteristics along with information identifying an inspection method. The system retrieves the corresponding inspection method information from the inspection method library (step 345) such as, e.g., from an inspection method library located at a remote site.

The system then combines the retrieved inspection method information with the description of the sequence of activities of the process flow (step 350). While combining the inspection method information with the process flow, the system can customize the inspection method to the particular circumstances of the process flow. For example, the inspection method information can be customized to account for the desired traits of an activity or the streams and equipment in an activity during execution. This may be accomplished using, e.g., inspection characteristics described in inspection characteristic field 235 of table 200. The system can also customize the inspection method to the characteristics of the other activities of the process flow, or to account for the particular placement of the inspection method within the process flow sequence of activities. For example, the system can identify the temperature or flow rate of a stream that is to be inspected, and customize the inspection method information to accommodate changes in measured parameters with temperature or flow rate.

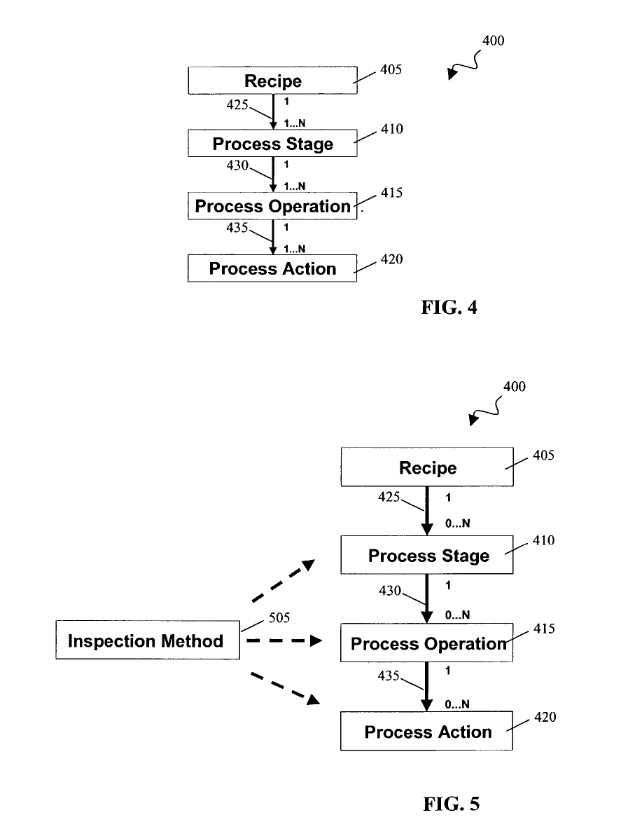

As shown in FIG. 4, one particular description of a process flow is found in a recipe 400. Recipe 400 organizes the process flow activities in a hierarchy and includes several different classes of process elements. In particular, recipe 400 includes a root recipe element 405, one or more process stage elements 410, one or more process operation elements 415, and one or more process action elements 420. Process elements 405, 410, 415, and 420 are independent of the resources deployed to perform the process flow described by recipe 400. Process elements 410, 415, and 420 depend from root recipe element 405. These elements are further described below.

Recipe 400 also includes links 425, 430, and 435 that interdependently link process elements 405, 410, 415, and 420 in the hierarchy with a cardinality from 1 to 1 . . . N. In particular, one or more links 425 form a parent-child relationship between parent recipe element 405 and process stage elements 410, one or more links 430 form a parent-child relationship between process stage elements 410 and process operation elements 415, and one or more links 430 form a parent-child relationship between process operation elements 415 and process action elements 420.

Elements 405, 410, 415, and 420 describe portions of the process flow in increasingly greater detail. Fewer or more levels can be included in the hierarchy of recipe 400 to describe the process flow, and the detail described at each level can be changed. However, in one embodiment, elements 405, 410, 415, and 420 describe the process flow as follows.

Recipe element 405 is the root element of recipe 400 and describes the process flow in general terms. Usually, all the activities necessary for the process flow depend from recipe element 405, and a recipe 400 need not possess more than one recipe element 405.

Recipe element 405 includes a serial or parallel sequence of process stages 410. Each process stage 410 can describe a portion of recipe element 405 that operates independently from other process stages 410. Each process stage 410 usually results in a planned sequence of chemical or physical changes in the material being processed. Examples process stages include activities like “drying” and “polymerization.” Each process stage 410 can be subdivided into a set of process operations 415. Each process operation 415 can be a processing activity that results in a physical, chemical, or biological change of a material or substance. Process operations 415 can be defined independently of the target equipment configuration. Examples process operations 415 include “degas solution to remove oxygen,” “bias electrode,” and “mix.” The difference between a process stage 410 and a process operation 415 can vary. In one embodiment of a recipe element 405, process operations 415 are independent of one another, whereas process stages 410 are dependent on other process stages 410. The example process stages 410 described above may not be independent of one other. For example, biasing an oxygen-sensitive material (which is one process stage) requires that the solution be previously degassed (which is another process stage).

Each process operation 415 can be subdivided into a set of process actions 420. Process actions 420 are the lowest level of processing within each recipe element 405. Each process action 420 can describe a relatively minor processing act in relatively great detail. Example process actions 420 include “heat to 100° C.,” “connect the positive lead to the electrode,” or “lower the electrode into solution.” Each process action 420 thus provides relatively detailed descriptions of the physical acts that are to be performed.

As shown in FIG. 5, quality management can be combined with recipe 400 using an inspection method 505. Inspection method 505 can be one or more activities that correspond to quality management of a process flow.

Inspection method 505 can either be associated with or integrated into a process element in recipe 400, or inspection method 505 can be added into the process, flow as an independent element. For example, inspection method 505 can describe activities at various levels of detail and can be inserted directly into a recipe hierarchy to populate the hierarchy. In particular, an inspection method 505 can be linked to root recipe 405 to form a process stage 410, an inspection method 505 can be linked to a process stage 410 to form a process operation 415, and an inspection method 505 can be linked to a process operation 415 to form a process action 420. Inspection method 505 can thus describe activities at levels of detail that correspond to the level of detail in process elements' 405, 410, 415, 420. For example, inspection method 505 can describe a quality management activity that operates independently of other activities. Alternatively, inspection method 505 can describe a quality management activity that manages a physical, chemical, or biological change of a material or substance. Inspection method 505 can also describe a relatively minor quality management activity in relatively great detail.

Inspection methods simplify quality management. Inspection activities can be changed, created, or deleted independently in each recipe without fear of losing the information in the source inspection methods. Moreover, when inspection methods are integrated directly into a process element, the inspection methods can be used for control of the activities described in the process element.

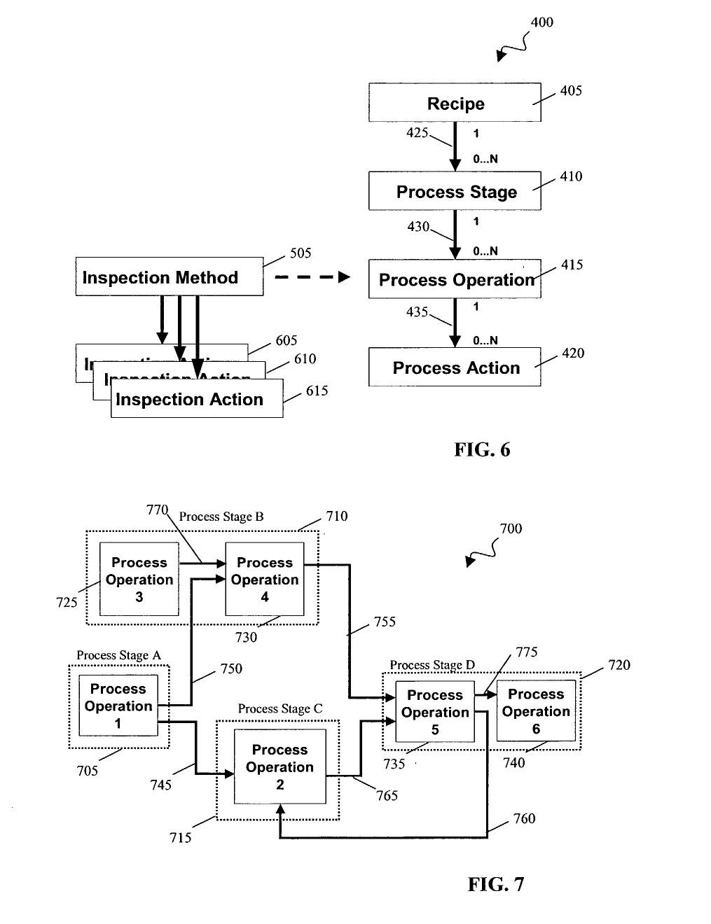

Inspection methods 505 can also have one or more dependent children inspection methods. Thus, more than one inspection method 505 can be added into recipe 400 individually or collectively. As shown in FIG. 6, inspection method 505 has three dependent children inspection methods 605, 610, 615 that follow inspection method 505 when inspection method 505 is combined with recipe 400.

As shown in FIG. 7, a process flow 700 can include multiple process stages 705, 710, 715, 720 organized as a set of serial and/or parallel elements. Process stage 710 includes a serial pair of process operations 725, 730, and process stage 720 includes a serial pair of process operations 735, 740.

Process stages 705, 710, 715, 720 are linked by a collection of stage links 745, 750, 755, 760, 765 that together describe the organization of process stages 705, 710, 715, 720 in the process flow. In particular, stage links 745, 750, 755, 760, 765 can describe either the temporal organization (i.e., order in time) of process stages 705, 710, 715, 720 or the flow stream of materials between process stages 705, 710, 715, 720.

Generally, the temporal organization of process stages 705, 710, 715, 720 follows the flow stream of materials in the process flow. For example, a process flow may require that a solvent be evaporated from a solution before a new material is mixed into the solution. The solution thus “flows” from distillation to mixing. However, the temporal organization of process stages 705, 710, 715, 420 does not necessarily follow the flow stream of materials. For example, a certain piece of equipment may be required for two stages of a process flow, and the timing of the stages can be staggered using links to ensure that the piece of equipment is not required simultaneously by both stages.

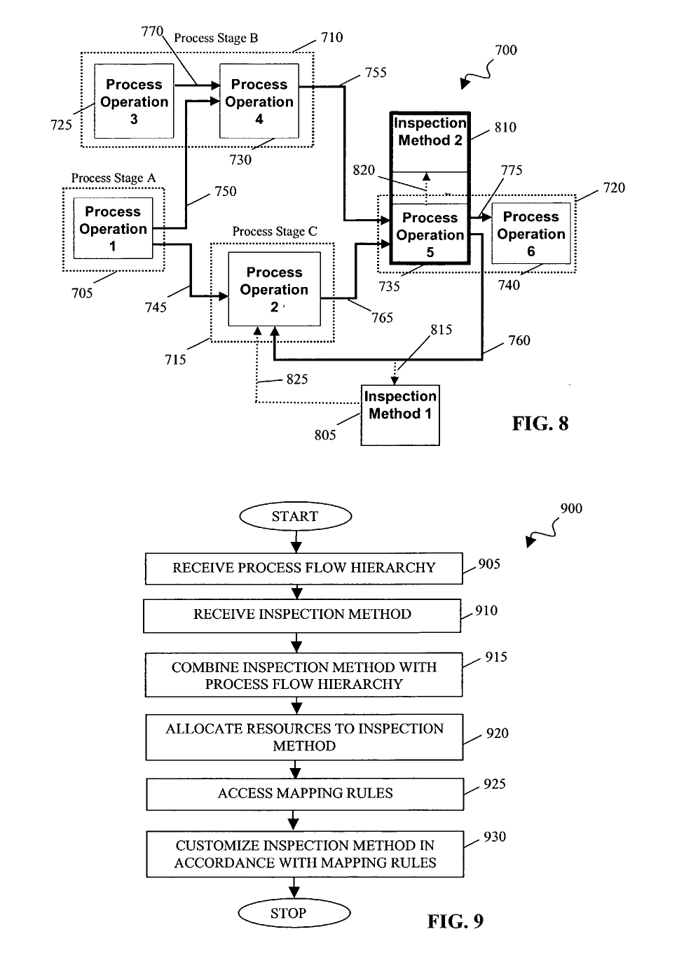

FIG. 8 shows process flow 700 after combination with quality management information. In the implementation shown in FIG. 8, stage links 745, 750, 755, 760, 765 describe flow streams of materials and process flow 700 includes inspection methods 805, 810. Inspection method 805 is an independent activity in a recipe hierarchy for managing the quality of the flow stream described by stage link 760. Inspection method 805 determines traits of the flow stream described by stage link 760, and receives a “flow stream” of information 815 about the materials in the flow stream described by stage link 760.

Inspection method 810 is a quality management activity that is associated with process element 735 for determining traits of the activity described by process operation 735. The traits of process operation 735 can include, e.g., ambient conditions, characteristics of equipment during execution of process operation 735, and properties of materials during execution of process operation 735. For example, inspection method 810 can determine the temperature of a vessel during a mixing operation described in process operation 735. Inspection operation 810 receives a “flow stream” of information 820 about the traits of the activity described by process operation 735.

Information 815, 820, received as a result of executing inspection methods 805, 810, can be used to monitor the execution of process flow 700, to ensure that the execution meets expectations, and to improve and/or debug process flow 700. For example, information 815 can be used to provide operational parameters 825 to process stage 715. As another example, information 815, 820 can be stored for each batch of product and later used to adjust the activities in process flow 700 to accommodate variability in starting materials and ambient operating conditions.

FIG. 9 shows another method 900 for combining quality management with recipes. A system performing method 900 receives a process flow hierarchy such as recipe 400 (step 905). The process flow hierarchy can be retrieved from a library of process flow hierarchies, copied from another process flow hierarchy, or can be received directly from a user. The system also receives an inspection method, such as inspection method 505 (step 910). The received inspection method can be an activity associated with another activity in the process flow, or the inspection method can be an independent element. The inspection method element can be retrieved from a library of inspection methods, copied from another process flow hierarchy, or can be received directly a user.

The system combines the inspection method element with the process flow hierarchy (step 915). In particular, the system can associate the inspection method with one or more activities in the process flow, or the system can link the inspection method to a process element in the process flow hierarchy as an independent element. The system can also add links that identify the flow stream of materials to and from the inspection method and/or the time sequence of the inspection method relative to other elements in the process flow hierarchy.

The system also allocates resources to the inspection method (step 920). The allocated resources can include a piece of equipment for performing the inspection method. For example, if the inspection method describes a method for measuring the transmissivity of a temporary suspension and the acceptable black noise of a spectrophotometer for making the transmissivity measurement, the system can allocate a particular spectrophotometer resource that is available at a site to perform the transmissivity measurement.

The system also accesses mapping rules that relate to execution of the inspection method using the allocated resources (step 925). Mapping rules are generic instructions that relate to the deployment of a particular resource. For example, mapping rules can include instructions for operating inspection equipment, such as the operational settings and parameters necessary to perform a desired inspection activity. Mapping rules can be included in a description of the allocated resource.

The system then customizes the inspection activity of the inspection method in accordance with the mapping rules (step 930). In particular, the system maps the activities in the inspection method to the resources that have been allocated. This customizes the inspection method for deployment of the allocated resources to perform the inspection activities.

The customized inspection activity need not be sufficient to immediately perform the inspection method. For example, the system can poll the user for additional instructions for deploying resources or to resolve conflicts that arise during customization.

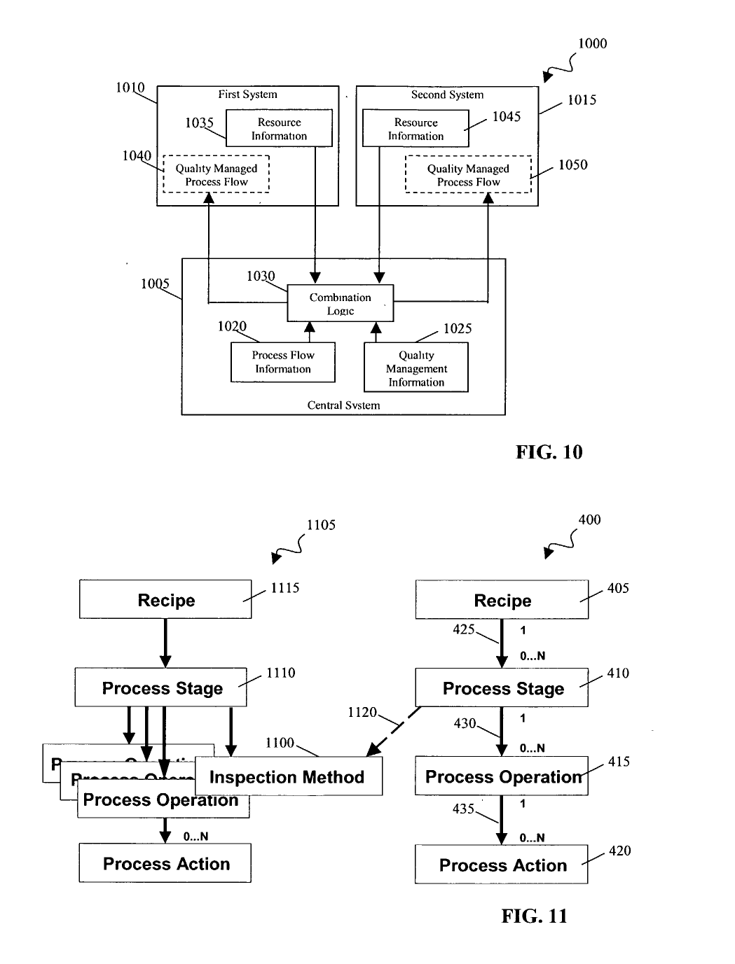

As shown in FIG. 10, a system 1000 for customizing a process flow in accordance with the invention includes a central system 1005, a first system 1010, and a second system 1015. Central system 1005 can be managed by, e.g., the owner of a branded product, while systems 1010, 1015 can belong to a site or a company that executes process flows. Central system 1005 can communicate with systems 1010, 1015 over a data transmission network.

Central system 1005 stores process flow information 1020, quality management information 1025, and quality management combination logic 1030. Process flow information 1020 describes a process flow. Quality management information 1025 describes the quality management of an activity described in process flow information 1020. Quality management combination logic 1030 includes instructions that cause a processor to combine quality management with an activity described in process flow information 1020.

First system 1010 includes resource information 1035 that describes the resources that are deployable by first system 1010 for performing an inspection method described by or identified in quality management information 1025. First system 1010 also includes a data storage device for storing a quality managed process flow 1040.

Second system 1015 includes resource information 1045 that describes the resources that are deployable by second system 1015 for performing the process flow. Second system 1015 also includes a data storage device for storing a quality managed process flow 1050.

In operation, central system 1005 receives and maintains process flow information 1020, quality management information 1025, and quality management combination logic 1030. If central system 1005 receives a request to combine quality management information 1025 with process flow information 1020 and allocate the equipment deployable by first system 1010, central system 1005 contacts first system 1010 to remotely access resource information 1035. First system 1010 can transmit resource information 1035 to central system 1005 over the data transmission network. Central system 1005 also accesses process flow information 1020 and quality management information 1025, and executes combination logic 1030 to combine quality management information 1025 with process flow information 1020 and allocate resources described by resource information 1035. For example, central system 1005 can perform method 900 by executing combination logic 1030. Central system 1005 thus creates quality managed process flow 1040 and then transmits quality managed process flow 1040 to first system 1010 over the data transmission network.

Alternatively, first system 1010 can generate the request for combination of quality management with process flow information 1020, and include resource information 1035 in the request.

A user may also wish to combine quality management information 1025 with process flow information 1020 and allocate resources deployable by second system 1015. When central system 1005 receives a second request to combine quality management information 1025 with process flow information 1020 and allocate the equipment deployable by first system 1010, central system 1005 contacts second system 1015 to remotely access resource information 1045. Second system 1015 can transmit resource information 1045 to central system 1005 over a data transmission network. Central system 1005 also accesses process flow information 1020 and quality management information 1025, and executes combination logic 1030 to combine quality management with process flow information 1020 and allocate resources described by resource information 1045. For example, central system 1005 can perform method 900 by executing combination logic 1030. Central system 1005 thus creates quality managed process flow 1050 and then transmits quality managed process flow 1050 to second system 1015 over the data transmission network.

Two or more distinct quality managed process flows 1040, 1050 can be created for two or more distinct sets of deployable resources from a single process flow. Since process flow information 1020, quality management information 1025, and combination logic 1030 do not leave central system 1005. A user of central system 1005 maintains control over process flow information 1020, quality management information 1025, and combination logic 1030. This can be important if, e.g., process flow information 1020, quality management information 1025, and combination logic 1030 include proprietary information.

Furthermore, since central system 1005 remotely accesses resource information 1035, 1045, central system 1005 need not maintain and update a resource information database that includes resource information for systems 1010, 1015. Also, a user of a system need not transmit resource information updates to one or more central systems. Rather, a system can store an updated version of the resource information and provide the updated resource information to one or more central systems upon request.

As shown in FIG. 11, quality management can also be combined with recipe 400 using a root-dependent inspection method 1100. In particular, a recipe hierarchy 1105 can include root-dependent inspection method 1100 that depends from a parent process stage 1110, which in turn depends from a parent root recipe element 1115. Root recipe element 1115 describes a process flow that is different from the process flow described by root recipe element, such as process operation 415. Alternatively, inspection method 1100 can be associated with a process element such as, e.g., process stage 1110.

Recipe 400 includes a reference link 1120 that refers to inspection method 1100. Through link 1120, the inspection activities and characteristics described by inspection method 1100 are included in recipe 400.

By referencing an inspection method, rather than copying the inspection method, inspection methods that already have, e.g., allocated resources or customized inspection activities can be directly included in recipe 400 without again undergoing resource allocation or mapping rule customization. This is particularly useful, e.g., when both recipe 1105 and recipe 400 are master recipes. For example, a master recipe 400 that has just been customized to the resources that are deployable at a particular site can simply refer to an existing inspection method in the other master recipe 1105. In this case, there is no need to include an inspection method in the general recipe from which master recipe 400 was created.

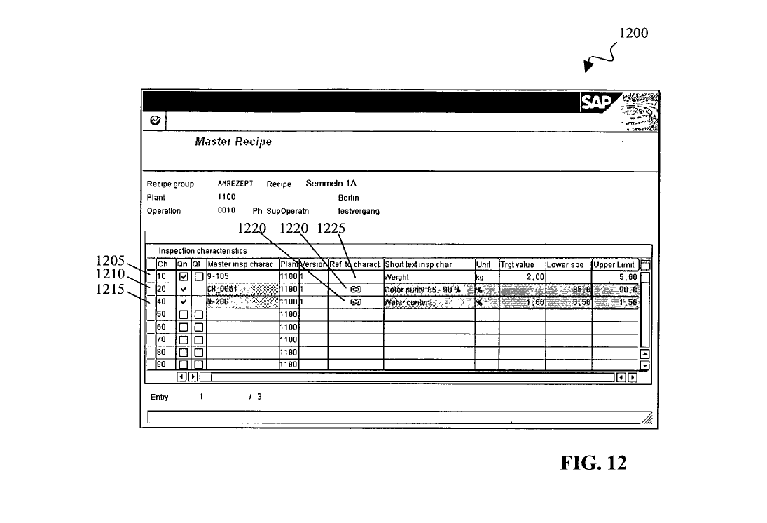

The inclusion of an inspection method in a recipe by reference (i.e., using a reference link 1120) need not be identical to the direct combination of an inspection method with the process flow of a recipe. For example, as shown in FIG. 12, an example screen display 1200 listing inspection characteristics 1205, 1210, 1215 of a recipe “Semmeln 1A” can indicate, using a lock icon 1220, that referenced inspection characteristics 1210, 1215 are fixed from within recipe “Semmeln 1A.” On the other hand, screen display 1200 can indicate that included inspection characteristic 1205 is alterable by the absence 1225 of a lock icon.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor, or embodied in a propagated signal, or embodied in any combination of the machine-readable storage device and the propagated signal. Method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (“application-specific integrated circuits”).

To provide for interaction with a user, the invention can be implemented on a computer system having a display device such as a monitor or LCD screen for displaying information to the user and a keyboard and a pointing device such as a mouse or a trackball by which the user can provide input to the computer system. The system can be programmed to provide a graphical user interface through which computer programs interact with users.

The system can include a back-end component, such as a data server. The system can also include a middleware component, such as an application server or an Internet server. The system can also include a front-end component, such as a client computer having a graphical user interface or an Internet browser. The components of the system can be connected by links, networks, or any combination of both.

A number of implementations of the invention have been described. Nevertheless, it will be understood that various modifications may be made. Accordingly, other implementations are within the scope of the following claims.

What is claimed is:

1. A computer-implemented method for combining quality management with a process flow, comprising:
receiving process flow information describing a sequence of activities in the process flow;
receiving quality management information describing quality management of a particular activity in the sequence; and
combining the quality management information with the process flow information.

2. The method of claim 1, wherein receiving quality management information comprises:
receiving an inspection method describing a method for managing quality of the particular activity; and
receiving an inspection characteristic identifying a trait of one of the particular activity and a stream in the particular activity during execution of the process flow.

3. The method of claim 2, wherein receiving the inspection characteristic comprises:
receiving an upper limit of a value of the trait.

4. The method of claim 1, wherein receiving quality management information comprises:
referencing the quality management information from a second process flow.

5. The method of claim 4, wherein referencing the quality management information from the second process flow comprises:
referencing the quality management information in a master recipe.

6. The method of claim 4, wherein referencing the quality management information from the second process flow comprises:
preventing change in the referenced quality management information.

7. The method of claim 1, wherein receiving quality management information comprises:
receiving instructions for deploying a resource to manage quality of the particular activity.

8. The method of claim 7, wherein receiving instructions for deploying the resource comprises:
generating instructions for deploying a piece of equipment based on information about operation of the piece of equipment.

9. The method of claim 7, wherein receiving instructions for deploying the resource comprises:
receiving instructions to manage quality of an output stream of the particular activity.

10. The method of claim 1, further comprising:
selecting a piece of equipment for managing quality of the particular activity in the sequence.

11. The method of claim 1, further comprising:
performing the process flow.

12. The method of claim 1, further comprising:
receiving second process flow information describing a second sequence of activities in a second process flow; and
combining the quality management information with the second process flow information.

13. The method of claim 1, wherein combining the quality management information with the process flow information comprises:
associating a quality management activity with an activity of the process flow.

14. The method of claim 13, wherein associating the quality management activity comprises:
associating a quality management activity with a process element in an element hierarchy, the process element describing an activity in the process flow.

15. The method of claim 1, wherein combining the quality management information with the process flow information comprises:
adding a quality management element into an element hierarchy, the element hierarchy including a collection of process elements describing activities in the process flow.

16. The method of claim 1, wherein receiving process flow information comprises:
receiving a sequence of activities for a conversion of a material.

17. A computer program product, tangibly stored on machine readable media, for combining quality management with a process flow, the product comprising instructions to cause a processor to:
combine a quality management method with a process element hierarchy having a root and describing a process flow, the quality management method describing an activity for managing the quality of the process flow described by the process element hierarchy.

18. The product of claim 17, wherein the wherein the instructions also cause the processor to:
retrieve the quality management element from a collection of quality management elements.

19. The product of claim 17, wherein the instructions cause the processor to:
insert the quality management element into the process flow hierarchy as one of a process stage element, a process operation element, and a process action element.

20. The product of claim 17, wherein the instructions cause the processor to:
combine the quality management method with the process element hierarchy by referencing a child method in a second process element hierarchy describing a second process flow.

21. The product of claim 20, wherein:
the process element hierarchy is part of a first master recipe; and
the child method is combined with a second master recipe.

22. The product of claim 17, wherein the instructions also cause the processor to:
receive information about the quality management method from a user.

23. The product of claim 17, wherein the instructions also cause the processor to:
allocate resources to the quality management method.

24. The product of claim 23, wherein the instructions also cause the processor to:
allocate equipment to the quality management method.

25. The product of claim 17, wherein the instructions also cause the processor to:
combine the quality management method with a second process flow hierarchy having a second root and describing a second process flow.

26. The product of claim 17, wherein the instructions also cause the processor to:
combine the quality management method with a master recipe.

27. The product of claim 17, wherein the instructions also cause the processor to:
combine the quality management method with a general recipe.

28. The product of claim 17, wherein the instructions also cause the processor to:
insert a quality management method into the process element hierarchy as an independent element.

29. The product of claim 17, wherein the instructions also cause the processor to:
combine an inspection method with the process element hierarchy, the inspection method describing an inspection activity for determining a trait of one of an activity in the process flow, a piece of equipment used in the process flow, and a stream in the process flow.

30. The product of claim 29, wherein the instructions also cause the processor to:
combine the inspection method with the process flow, the inspection method including an inspection characteristic describing a desired value of the trait with the process flow.

31. The product of claim 17, wherein the instructions also cause the processor to:
customize the quality management method to a characteristic of the process element hierarchy.

32. The product of claim 17, wherein the instructions also cause the processor to:
account for the particular placement of the quality management method within the process element hierarchy.

33. The product of claim 17, wherein the instructions also cause the processor to:
combine the quality management method with the process flow hierarchy, the process flow hierarchy describing a sequence of activities for a conversion of a material.
